(19) United States
(12) Patent Application Publication
(10) Pub. No.: US 2016/0306800 A1
(43) Pub. Date: Oct. 20, 2016

(54) REPLY RECOMMENDATION APPARATUS AND SYSTEM AND METHOD FOR TEXT CONSTRUCTION

(71) Applicant: FLUENTY KOREA INC., Seoul (KR)

(72) Inventors: Jeong Hoon SON, Seoul (KR); Kang Hak KIM, Gyeonggi-do (KR); Sung Jae HWANG, Seoul (KR)

(73) Assignee: FLUENTY KOREA INC., Seoul (KR)

(21) Appl. No.: 14/925,158

(22) Filed: Oct. 28, 2015

(30) Foreign Application Priority Data
Apr. 16, 2015 (KR) 10-2015-0054021
Jul. 31, 2015 (KR) 10-2015-0109119

(51) Int. Cl. G06F 17/30; H04L 12/58

(52) U.S. Cl. CPC G06F 17/3053; H04L 51/32; G06F 17/30598; G06F 17/30917

(57) ABSTRACT

Provided are a reply recommendation apparatus using collected data, and a system and method for automatic text construction. The reply recommendation apparatus includes a data collecting unit collecting dialog pair data including parent text data corresponding to a query and child text data, a data pre-processing unit pre-processing the collected data pair data, a vectorizing unit matching the pre-processed data to particular points on the coordinate system having predefined axes, a clustering unit performing clustering using information on the matched particular points and merging all or some of texts included in one of clusters using a preset merging method, a ranking unit scoring the degree of appropriateness as a reply to the received message for each of the clusters using a first preset scoring method, and a recommended reply providing unit providing recommended replies sequentially represented by high score assigned when the ranking unit scores the degree of appropriateness.

### CROSS-REFERENCE TO RELATED APPLICATION

This application claims priority from Korean Patent Application No. 10-2015-0054021 filed on Apr. 16, 2015 and Korean Patent Application No. 10-2015-0109119 filed on Jul. 31, 2015 in the Korean Intellectual Property Office, and all the benefits accruing therefrom under 35 U.S.C. 119, the contents of which in its entirety are herein incorporated by reference.

### BACKGROUND

1. Field of the Invention

The present invention relates to a reply recommendation apparatus and method, and more particularly to a reply recommendation apparatus for providing adaptive reply candidates using collected data, and a system and method for automatic text construction.

2. Description of the Related Art

In recent years, with the progress of general-purpose handheld, mobile smart devices, such as laptop computers, smart phones, or smart pads, wearable devices which can be always worn by users, such as smart glasses, smart watches, smart rings, or smart necklaces, have begun to gradually gain wider acceptance and application in a variety of fields.

Since the wearable device is ordinarily worn on user's body, it is physically restricted in its shape or size. For example, since a user's wrist-worn smart watch needs to have an unobtrusive design in view of its shape or size, compared to traditional wrist watches, it is quite difficult to mount a large-sized display on a wearable device, unlike a laptop or a smart pad.

As shown in FIG. 1, the wearable device includes only a small size display, and it is quite difficult to properly allow for user interface required for a user to manipulate a variety of tasks or to input messages unlike the traditional keyboard. When the user interface having the same type as the traditional keyboard, as shown in FIG. 1, is provided through the wearable device, the small size display makes it quite difficult for the user to perform accurate data input.

FIG. 2 is a diagram illustrating an example of a conventional method for transmitting a message through a wearable device.

Referring to FIG. 2, as the conventional method proposed for overcoming the aforementioned problem, there has been proposed technology for providing a user interface allowing messages to be input within a range of pre-stored data of representative examples of habitually used common phrases.

However, according to the conventional technology, since only the common phrases without consideration taken into context data relating to user's current situation, it is difficult to offer a phrase conforming to user's intent.

To offer phrases suitable for user's intent, a large quantity of phrases may be presented. In such a case, however, it is also cumbersome to choose a phrase conforming to user's intent among the large quantity of phrases.

### SUMMARY

The present invention provides a reply recommendation apparatus and method, which can provide a recommended message expected to be made by a user based on context data relating to a user's current situation in which the user makes a reply to a received message.

The present invention also provides a reply recommendation apparatus and method, which allows an adequate message conforming to user's intent to be easily selected.

The present invention also provides a reply recommendation apparatus and method, which can recommend a reply message to a user in consideration of time, place, user's situation, user's intonation, user's tone or trend.

The present invention also provides a reply recommendation apparatus and method, which can execute a specific application or can recommend execution of a specific application in response to a received message.

These and other objects of the present invention will be described in or be apparent from the following description of the preferred embodiments.

According to a first aspect of the present invention, there is provided a reply recommendation apparatus including a data collecting unit collecting dialog pair data including parent text data corresponding to a query and child text data corresponding to a reply to the query, a data pre-processing unit pre-processing the collected data pair data, a vectorizing unit matching the pre-processed data to particular points on the coordinate system having predefined axes, a clustering unit performing clustering using information on the matched particular points and merging all or some of texts included in one of clusters using a preset merging method, a ranking unit scoring the degree of appropriateness as a reply to the received message for each of the clusters using a first preset scoring method, and a recommended reply providing unit providing recommended replies sequentially represented by high scores assigned when the ranking unit scores the degree of appropriateness.

In an embodiment of the present invention, the reply recommendation apparatus may further include a grouping unit grouping the clusters having scores higher than a first preset score or grouping a predetermined number of clusters having scores represented in a descending order according to predetermined grouping criteria, wherein the recommended reply providing unit sequentially provides texts included in clusters of different groups resulting from the grouping, instead of consecutively providing texts included in clusters of the same group.

In an embodiment of the present invention, the data collecting unit may collect the dialog pair data on a social network service (SNS), and the data pre-processing unit may remove SNS data characteristics from the dialog pair data collected on the SNS.

In an embodiment of the present invention, the data pre-processing unit separating a text on a token basis with respect to the dialog pair data from which the SNS data characteristics are removed and performing part-of-speech (POS) tagging on each token.

In an embodiment of the present invention, the data pre-processing unit may perform entity extraction and metadata mapping on the POS tagged dialog pair data.

In an embodiment of the present invention, the predefined axes may include at least one of text types and characteristics of words included in the text.

In an embodiment of the present invention, the ranking unit may perform scoring on the clusters assigned with higher scores according to the bigger sizes of the clusters.

In an embodiment of the present invention, the ranking unit may perform scoring on texts existing in the grouped clusters using a second preset scoring method.

In an embodiment of the present invention, the recommended reply providing unit may provide recommended replies temporally in different ways based on scores assigned using the second preset scoring method.

In an embodiment of the present invention, the recommended reply providing unit may provide recommended replies in a visually distinctive manner by varying at least one of placement order, letter size, touch area size, letter color, letter background color and letter resolution according to the scores assigned using the second preset scoring method.

In an embodiment of the present invention, the recommended reply providing unit may provide recommended replies in an auditorily distinctive manner based on scores assigned using the second preset scoring method.

In an embodiment of the present invention, the recommended reply providing unit may provide recommended replies in an auditorily in different ways by varying at least one of volume, intonation and tone.

In an embodiment of the present invention, the grouping unit may perform grouping using at least one of information relating to cluster placement areas on the coordinate system and contextual content of each of texts included in the clusters.

In an embodiment of the present invention, the grouping unit may perform grouping by additionally using at least one of receiving time of the received message, receiving place of the received message, sex of receiving user of the received message, and age of receiving user of the received message.

In an embodiment of the present invention, the degree of grouping performed by the grouping unit may be changed according to the number of clusters to be grouped.

In an embodiment of the present invention, the data collecting unit may collect information relating to user's reply to the received message and the ranking unit may use the information relating to user's reply in the scoring.

In an embodiment of the present invention, the data collecting unit may collect information relating to an application executed immediately after receiving a particular message, when the same message as the particular message or a message similar to the particular message on the basis of a preset similarity level is received again, the ranking unit may perform scoring on the received message by application based on the information relating to application execution, and the recommended reply providing unit may provide a text “Execute the application assigned with a higher score than a second preset score.” as the recommended reply to the same or similar message.

In an embodiment of the present invention, the data collecting unit may collect information relating to an application executed immediately after receiving a particular message, when the same message as the particular message or a message similar to the particular message on the basis of a preset similarity level is received again, the ranking unit may performs scoring on the received message by application based on the application executing information, and the reply recommendation apparatus may further include an application execution unit automatically executes the application assigned with the highest score when the same message as the particular message or a message similar to the particular message.

According to a second aspect of the present invention, there is provided a reply recommendation apparatus including a data collecting unit collecting dialog pair data including parent text data corresponding to a query and child text data corresponding to a reply to the query, a data pre-processing unit pre-processing the collected data pair data, a vectorizing unit matching the pre-processed data to particular points on the coordinate system having predefined axes, a clustering unit performing clustering using information on the matched particular points and merging similar texts included in one of clusters using a preset merging method, a ranking unit scoring the degree of appropriateness as a reply to the received message for each of the merged texts included in the clusters after the merging, a grouping unit grouping the texts having scores higher than a preset score or grouping a predetermined number of texts in descending order starting from one having the highest score according to predetermined grouping criteria, and a recommended reply providing unit sequentially providing texts of different groups resulting from the grouping, instead of consecutively providing texts of the same group.

In an embodiment of the present invention, the ranking unit may calculate a probability of the merged texts appearing after the received message and may perform scoring on the merged texts based on the calculated probability.

According to a third aspect of the present invention, there is provided a reply recommendation method including collecting dialog pair data including parent text data corresponding to a query and child text data corresponding to a reply to the query, pre-processing the collected data pair data, matching the pre-processed data to particular points on the coordinate system having predefined axes, performing clustering using information on the matched particular points and merging similar texts included in one of clusters using a preset merging method, scoring the degree of appropriateness as a reply to the received message for each of the merged texts included in the clusters after the merging, grouping the texts having scores higher than a preset score or grouping a predetermined number of texts in descending order starting from one having the highest score according to predetermined grouping criteria, and sequentially providing texts of different groups resulting from the grouping, instead of consecutively providing texts of the same group.

According to a fourth aspect of the present invention, there is provided a reply recommendation method including collecting dialog pair data including parent text data corresponding to a query and child text data corresponding to a reply to the query, pre-processing the collected data pair data, matching the pre-processed data to particular points on the coordinate system having predefined axes, performing clustering using information on the positioned particular points and merging all or some of texts included in one of clusters using a preset merging method, scoring the degree of appropriateness as a reply to the received message for each of the clusters using a first preset scoring method, grouping the clusters having scores higher than a first preset score grouping a predetermined number of clusters having scores represented in descending order according to predetermined grouping criteria, and providing recommended replies sequentially represented by starting from one having the highest score assigned in the scoring of the degree of appropriateness.

According to a fifth aspect of the present invention, there is provided a computer program in combination with hardware, the computer program stored in a medium to perform one of the reply recommendation methods.

As described above, according to the present invention, a recommended message expected to be made by a user based on context data relating to a user's current situation in which the user makes a reply to a received message can be provided.

On addition, an adequate message conforming to user's intent is allowed to be easily selected.

Further, a reply message can be recommended to a user in consideration of time, place, user's situation, user's intonation, user's tone or trend.

Additionally, a specific application can be executed or execution of a specific application can be recommended, in response to a received message.

### BRIEF DESCRIPTION OF THE DRAWINGS

The above and other features and advantages of the present invention will become more apparent by describing in detail preferred embodiments thereof with reference to the attached drawings in which:

FIG. 1 is a diagram illustrating an exemplary user interface provided by a wearable device;

FIG. 2 is a diagram illustrating an example of a conventional method for transmitting a message through a wearable device;

FIGS. 3 and 4 are diagrams schematically illustrating environments to which a reply recommendation apparatus according to an embodiment of the present invention is applied;

FIG. 5 is a diagram schematically illustrating environments to which a reply recommendation apparatus according to another embodiment of the present invention is applied;

FIG. 6 is a block diagram of a reply recommendation apparatus (100) apparatus according to an embodiment of the present invention;

FIG. 7 is a diagram illustrating an exemplary internal configuration of a text construction system (200) according to another embodiment of the present invention;

FIGS. 8 to 10 illustrate an example of a data pre-processing operation;

FIG. 11 is a diagram illustrating an example of a vectorizing operation of pre-processed data;

FIG. 12 is a diagram illustrating an example of a clustering operation performed by a clustering unit;

FIG. 13 is a diagram illustrating an example of a clustering operation based on a received message;

FIG. 14 is a diagram illustrating an example of a scoring operation performed by a ranking unit;

FIG. 15 is a diagram illustrating a grouping result of recommended replies;

FIG. 16 is a diagram illustrating an example of providing recommended replies in a visually distinctive manner;

FIG. 17 is a diagram illustrating an example of personalized scoring;

FIG. 18 is a diagram illustrating an example of scoring with consideration taken into user's intent;

FIG. 19 is a diagram illustrating an example of a text construction system (200) storing log data relating to multiple users using a feedback collecting unit (255);

FIG. 20 is a flowchart of a reply recommendation method according to another embodiment of the present invention; and

FIG. 21 is a diagram illustrating an exemplary hardware configuration of a reply recommendation apparatus according to an embodiment of the present invention.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terminology used herein is for the purpose of describing particular embodiments only and is not intended to be limiting of the invention.

As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

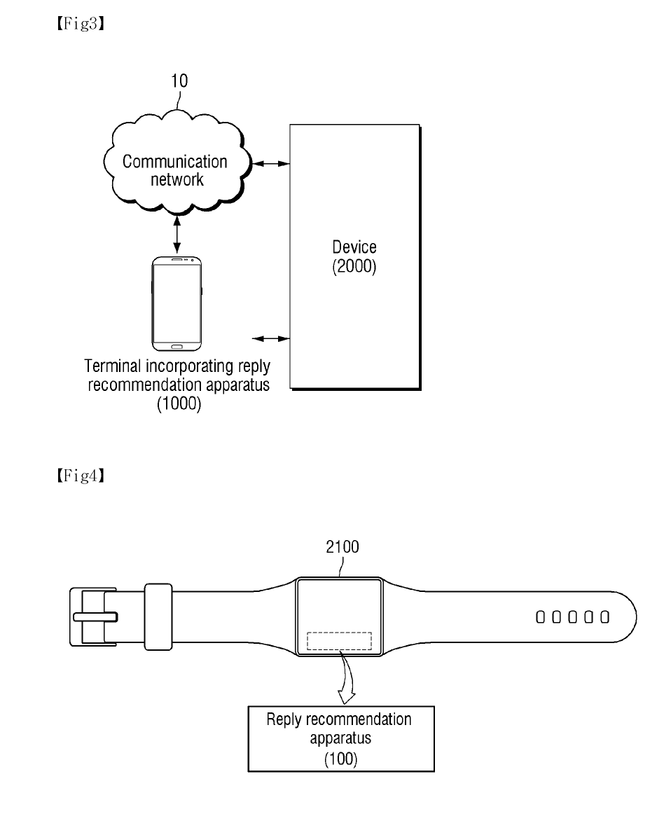

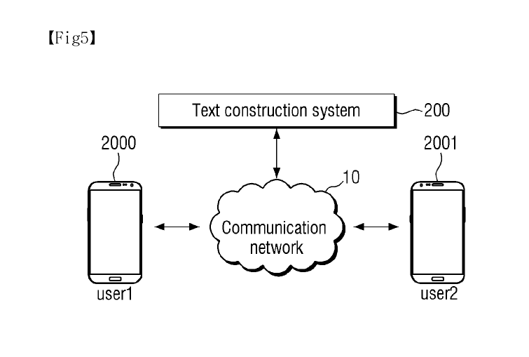

FIGS. 3 and 4 are diagrams schematically illustrating environments to which a reply recommendation apparatus according to an embodiment of the present invention is applied.

Referring to FIG. 3, the reply recommendation apparatus 100 may be incorporated into a terminal 1000.

The terminal 1000 may be provided as a desk-top computer, a work station, a personal digital assistant (PDA), a portable computer, a wireless phone, a mobile phone, a smart phone, an e-book, a portable multimedia player (PMP), a potable game console, a navigation device, a black box, a digital camera, a television, a device capable of transmitting/receiving information in wireless environments, one of various electronic devices constituting a home network, one of various electronic devices constituting a computer network, one of various electronic devices constituting a telematics network, a smart card, or one of various components constituting a computing system.

A device 2000 of any type may include a wearable device, such as smart glasses, a smart watch, a smart ring, or a smart necklace.

The terminal 1000 incorporating the reply recommendation apparatus 100 is capable of transmitting/receiving data to/from the device 2000 through a communication network 10.

The communication network 10 may be constructed in any type of wired communication or wireless communication and may include a wide variety of communication networks, such as a local area network (LAN), a metropolitan area network (MAN), or a wide area network (WAN). Preferably, the communication network 10 as used herein may be the Internet or the world wide web (WWW) publicly known, but the communication network 10 is not limited thereto but may include, at least in part, known wired/wireless data communication networks, known telephone networks or known wired/wireless television communication networks.

Alternatively, the terminal 1000 incorporating the reply recommendation apparatus 100 may transmit/receive data by being directly connected to the device 2000 or through the Bluetooth.

As shown in FIG. 4, the reply recommendation apparatus 100 may be incorporated into a wearable device 2100.

The reply recommendation apparatus 100, which is incorporated into the wearable device 2100, may assist the user in making a reply message through the wearable device 2100.

FIG. 5 is a diagram schematically illustrating environments to which a reply recommendation apparatus according to another embodiment of the present invention is applied.

The reply recommendation apparatus according to another embodiment of the present invention may include a communication network 10, a text construction system 200, and devices 2000 and 2001 of users 1 and 2.

The text construction system 200 may include a digital device including a memory and a microprocessor having computing capability. The text construction system 200 may be a server system.

The text construction system 200 may be provided in a separate external system, rather than within the terminal 1000 or the devices 2000 and 2001, thereby performing functions similar to those of the reply recommendation apparatus 100. That is to say, the text construction system 200 may perform an adaptive text constructing function by searching at least one candidate text expected to be made by the user based on the context data relating to user's message making situation, and if one text object is selected among text objects included in the at least one searched candidate texts, providing at least one alternative text, which has the degree of relatedness with a first text object is greater than or equal to a preset level, in the form associated with the first text object.

In addition, the text construction system 200, as will later be described in detail, searches at least one candidate message expected to be made by the user based on the context data relating to user's message making situation, separates at least some of the at least one searched candidate message on a predetermined unit basis to then generate at least one candidate letter object, matches the at least one generated candidate letter object to at least one virtual key included in a virtual keyboard to then indicate the at least one matched candidate letter object, and provides the at least one alternative letter object having the degree of relatedness with the at least one indicated candidate letter object greater than or equal to a preset level, in the form associated with the first candidate letter object, thereby providing an adaptive keyboard interface providing function.

In addition, the text construction system 200 may store dialog content received from the devices 2000 and 2001 or data relating to dialogs exchanged between the devices 2000 and 2001, and may further perform a function of allowing the stored data to be recycled by the respective devices 2000 and 2001 or to be used for the dialogs exchanged between the devices 2000 and 2001. The storage may be performed in a storage (not shown) included in the text construction system 200. The storage may mean database including a computer-readable recording medium in a narrow sense and database including a file system based data record in a broad sense.

The reply recommendation apparatus 100 shown in FIGS. 3 and 4 or the text construction system 200 shown in FIG. 5 may be used in dialogs between the user and a system, may participate in messenger dialogs between users to then provide appropriate replies or may provide the users with a deep link suitable for the dialogs together with replies.

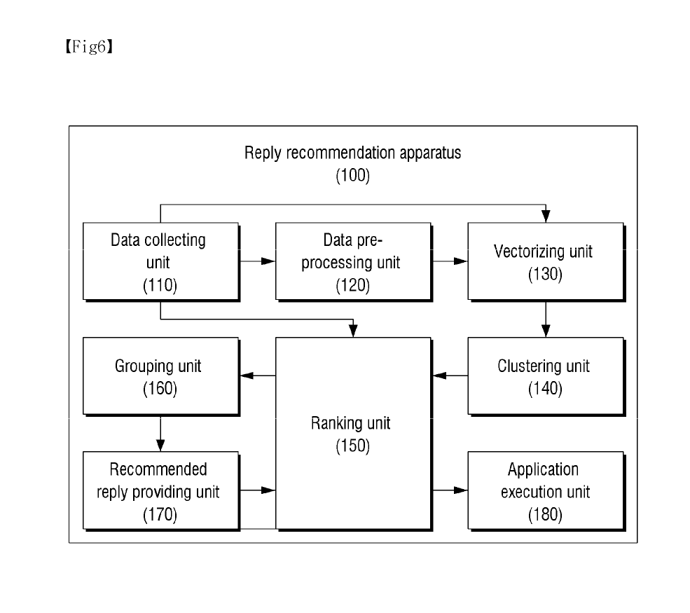

FIG. 6 is a block diagram of a reply recommendation apparatus (100) apparatus according to an embodiment of the present invention.

Referring to FIG. 6, the reply recommendation apparatus 100 according to an embodiment of the present invention includes a data collecting unit 110, a data pre-processing unit 120, a vectorizing unit 130, a clustering unit 140, a ranking unit 150, a grouping unit 160, and a recommended reply providing unit 170, and may further include an application execution unit 180.

The data collecting unit 110 may messages between the users and may collect messages sent in response to the received messages as dialog pair data.

The dialog pair data may include parent text data corresponding to a query and child text data corresponding to a reply to the query.

The parent text data corresponding to the query may include, for example, a text included in the received message. The child text data corresponding to the reply may include, for example, a text included in a reply message for the received message.

In addition, the data collecting unit 110 may collect dialog pair data from data acquired through the SNS, e.g., Twitter, or data from online sources, e.g., blogs.

The dialog pair data collected from the SNS may include a text included in the post posted by a person as a parent text corresponding to a query and a text included in the post posted by another person as a child text corresponding to a reply to the query.

Here, the parent text corresponding to the query may not be necessarily a text having a mark “?” but may be a variety types of texts, including a declarative text. The parent text may be determined in consideration of the context or the stream of conversation. In addition, each of the parent text and the child text may not be necessarily a text but may consist of one or more words.

The data collecting unit 110 does not necessarily collect only the dialog pair data but preferably collects the dialog pair data to get understanding of the contextual streams or situation.

The data pre-processing unit 120 may pre-process the collected dialog pair data for management of data and generation of reply candidate data.

In detail, the data pre-processing unit 120 may refine expressions of the collected dialog pair data and may extract dialog pairs suited to purposes.

The dialog pair data pre-processed by the data pre-processing unit 120 may be used in generating the reply candidate data suitable for the received message and deducing recommended replies.

The reply candidate data as used herein may mean data relating to replies having the even little likelihood that they are potential replies to the received message. The recommended replies are texts that are visually and/or auditorily presented to the user through the vectorizing unit 130, the clustering unit 140 and the ranking unit 150 as replies to be highly likely selected by the user while conforming to user's intent.

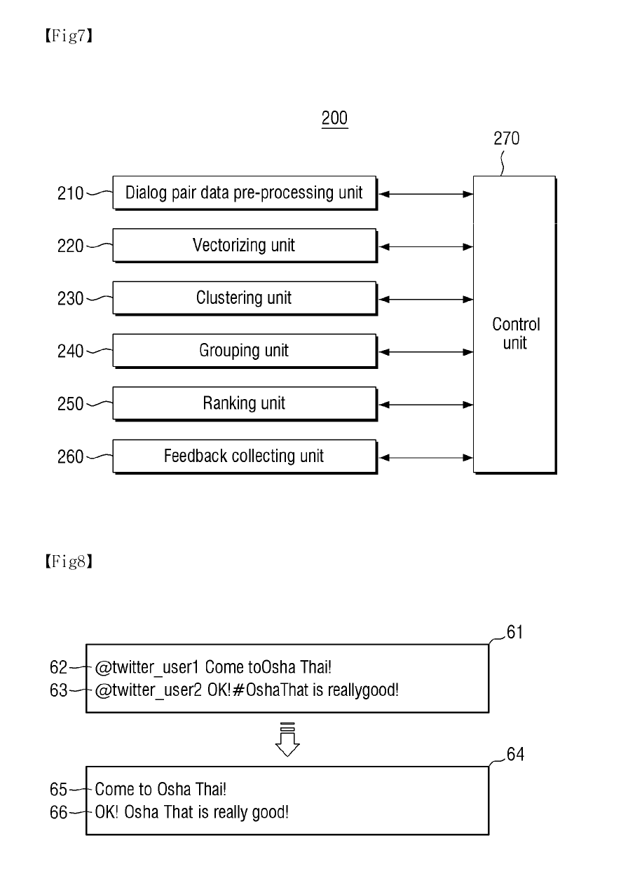

FIG. 7 is a diagram illustrating an exemplary internal configuration of a text construction system (200) according to another embodiment of the present invention.

Referring to FIG. 7, the text construction system 200 may include a dialog pair data pre-processing unit 210, a vectorizing unit 220, a clustering unit 230, a grouping unit 240, a ranking unit 250, a feedback collecting unit 260, a communication unit (not shown), and a control unit.

At least some of the dialog pair data pre-processing unit 210, the vectorizing unit 220, the clustering unit 230, the grouping unit 240, the ranking unit 250, the feedback collecting unit 260, the communication unit (not shown) and the control unit may be program modules communicating with an external system (not shown). The program modules may be incorporated into the text construction system 200 in forms of operating systems, application program modules and other types of program modules and may be physically stored in various known storage devices. In addition, the program modules may also be stored in a remote storage device capable of communicating with the text construction system 200. Meanwhile, the program modules may include, for example, routines, sub-routines, programs, objects, components and data formats for executing specific types of abstract data, but not limited thereto.

Next, operations of the data pre-processing unit 120 and the dialog pair data pre-processing unit 210 will be described in detail with reference to FIGS. 8 to 10.

FIGS. 8 to 10 illustrate an example of a data pre-processing operation performed by a data pre-processing unit (120) or a dialog pair data pre-processing unit (210). [000100]Throughout the specification of the present invention, a data pre-processing process for the data pre-processing unit 120 will be described, but aspects of the present invention are not limited thereto. The same data pre-processing process may also be applied to the dialog pair data pre-processing unit 210.

Referring to FIG. 8, noises based on SNS characteristics are removed from dialog pair data 61 collected from post content posted on an SNS site, such as Twitter, and texts of the noise-removed dialog pair data 61 may be segmented on a token basis by the data pre-processing unit 120.

In detail, the data pre-processing unit 120 may remove noises caused by SNS characteristics, such as mention (@), hash tag (#), etc., from the collected dialog pair data 61 and may separate each text into word tokens.

The dialog pair data pre-processing unit 210 may collect dialog pair data in a conversation between the devices 2000 and 2001 of users 1 and 2 and may remove noises due to characteristics of a messenger-to-messenger conversation to then segment the text on the token basis.

In FIG. 8, if a parent text “@twitter_user1 Come to Osha Thai!” 62 in the dialog pair data is pre-processed by the data pre-processing unit 120, the pre-processed parent text “Come to Osha Thai!” 65 is created.

In addition, if a child text “@twitter_user2 OK!#Osha Thai is really good!” 63 in the dialog pair data is pre-processed by the data pre-processing unit 120, the pre-processed child text “OK! Osha Thai is really good!” 66 is created.

The data pre-processing unit 120 may include a processor for performing POS tagging in pre-processing the dialog pair data. The POS tagging will now be described with reference to FIG. 8. If the data pre-processing unit 120 performs POS tagging on a parent text “@twitter_user1 I'm coming late. Sorry!” 72 in dialog pair data 71, the POS tagged data “Noun_Verb_Present Particle_Adjective_Noun_Exclamation” 75 may be created. In addition, if the data pre-processing unit 120 performs POS tagging on a child text “@twitter_user2 You are forgiven! It's fine” 66 in the dialog pair data 71, the POS tagged data “Noun_Verb_Past Particle_Exclamation_Noun_Verb_Adjective” 76 may be created.

The POS tagged data “Noun_Verb_Present Particle_Adjective_Noun_Exclamation” 75 may be designated in abbreviated forms using acronyms, that is, “N V VP A N !,” to then be stored.

The data pre-processing unit 120 may also include processors for performing individual extraction and meta data tagging in pre-processing the dialog pair data.

For example, when the parent text is “@twitter_user1 Are you going to buy the new iPhone?” and the child texts are “@twitter_user2 Yes! I think so. There's a promotion on Apple Store located at Union Square.” in the collected dialog pair data, the data pre-processing unit 120 may manage the dialog pair data by extracting an entity “Product name: iPhone_meta data: {url: http://apple.com/iPhone}, Store name: Apple Store, Place name: Union Square_meta data: {GPS: (37.0, −122.0)}” 84 and tagging meta data.

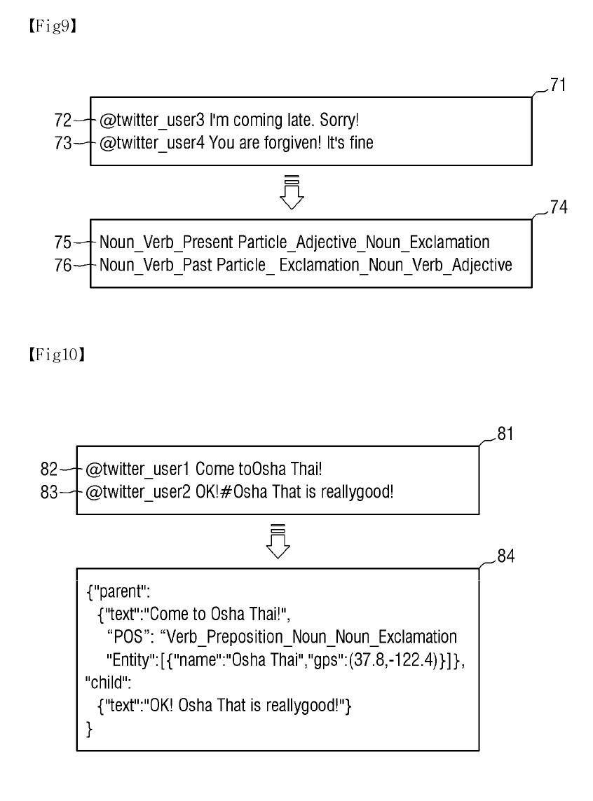

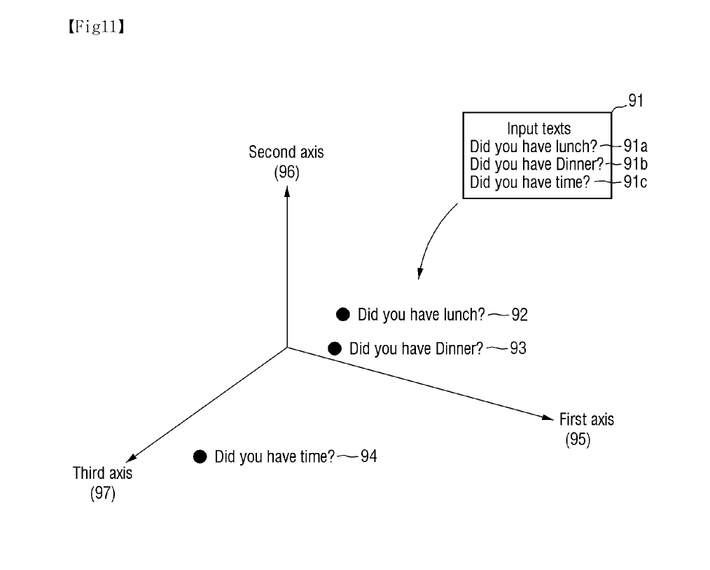

An example of the dialog pair data pre-processed by the data pre-processing unit 120 may be understood with reference to FIG. 9.

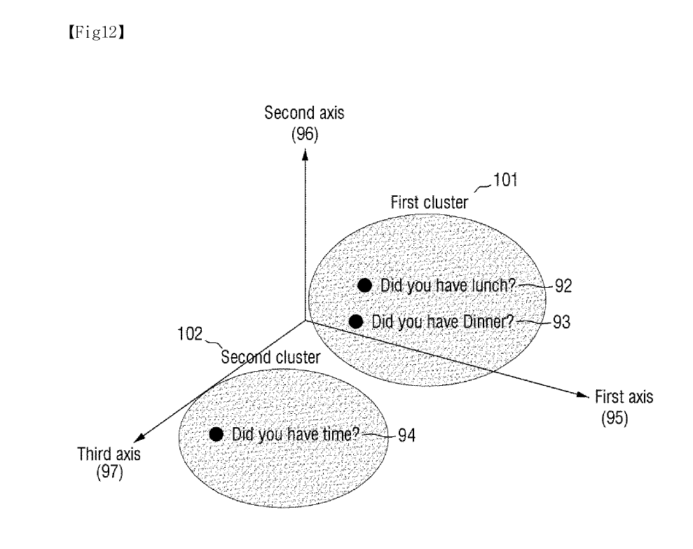

Referring to FIG. 10, final data 84 pre-processed by the data pre-processing unit 120 are proposed for dialog pair data 81(“@twitter_user1 Come to Osha Thai!” 82 and “@twitter_user2 Ok! #Osha Thai is really good” 83.

In the pre-processed final data 84, parent text data, child text data, POS tagging data, entity data and metadata are included.

The data pre-processing unit 120 may additionally include a processor for removing data relating to personal information, such as address, phone number or identification number, etc., from the dialog pair data.

The above-described method may also be applied to the data pre-processing process performed on the dialog pair data collected from the conversation between the devices 2000 and 2001 by the dialog pair data pre-processing unit 210.

Referring again to FIG. 6, the vectorizing unit 130 may map the pre-processed data to particular points on the coordinate system having two or more predefined axes. The mapping of the pre-processed data to particular points on the coordinate system is referred to as vectorizing. Alternatively, the vectorizing unit 130 may map the pre-processed data to particular points on the coordinate system on a pre-processed data basis.

The pre-processed data may be reply candidate data in whole or in part.

In detail, the reply candidate data may be selected among the pre-processed data and determined according to the currently received message.

The predefined axes may include data relating to text types (for example, declarative text, interrogative text, imperative text, exclamatory text, or optative text) and/or features of words included in the text (for example, location, time, figure, event, article class, or figures' jobs), and combinations thereof.

The vectorizing unit 130 may vectorize all of the pre-processed data. The coordinate system generated by the predefined axes may include two or more coordinate systems. That is to say, the vectorizing unit 130 may vectorize first pre-processed data on both of a first coordinate system and a second coordinate system.

Alternatively, the vectorizing unit 130 may vectorize, among the pre-processed data, only a portion of the data relating to the received message or a parent text according to the received message or the parent text.

The vectorizing unit 130 preferably vectorizes texts such that semantically similar texts exist on near locations. The semantic similarity of each text may be determined according to the information and features of the predefined axes.

Referring to FIG. 7, the vectorizing unit 220 may vectorize all of the pre-processed data by mapping the pre-processed data to particular points on a plane or spatial coordinate system consisting of two or more predefined axes on a pre-processed data basis, like the vectorizing unit 130 shown in FIG. 6.

FIG. 11 is a diagram illustrating an example of a vectorizing operation of pre-processed data.

Referring to FIG. 11, in the vectorizing operation, texts “Did you have lunch?,” “Did you have dinner?” and “Did you have time?” as pre-processed data 91 may be positioned to respectively mapped coordinates 92, 93 and 94 using characteristics of a first axis 96, a second axis 97 and a third axis 98. As shown in FIG. 11, meal-related interrogative texts “Did you have lunch?” and “Did you have dinner?” exist near locations on the coordinate system. However, a time-related interrogative text “Did you have time?” exists relatively far from the meal-related interrogative texts.

However, the locations of the respective texts may vary according to the change in the predefined axes. That is to say, if the predefined axes are changed, the degree of similarity between texts may also be changed.

The predefined axes may be changed according to not only the received message but system setting or updating.

The vectorizing unit 220 may also change the degree of similarity between texts, like the vectorizing unit 130 and may vectorize texts for presenting adaptively constructed texts to a virtual keyboard between the devices 2000 and 2001 involving a messenger conversation.

Referring again to FIG. 6, the clustering unit 140 may perform clustering using the data vectorized by the vectorizing unit 130. In addition, the clustering unit 140 may merge similar texts having a higher degree of similarity than a preset similarity level, among the texts represented by the pre-processed data included in one of clusters, according to a preset merging method. The preset merging method may allow similar texts to be merged using ontology, existing known methods, predefined data regarding word similarities, and so on.

In detail, the clustering unit 140 may represent similar texts in a cluster. The clustering unit 140 may grasp the degree of text similarity using coordinate data of the texts. For example, the clustering unit 140 may represent texts existing within a predefined distance from a particular point to be included in a cluster. Alternatively, the clustering unit 140 may represent texts whose coordinates are placed within a predefined distance to be included in a cluster.

Referring back to FIG. 7, the clustering unit 230 of the text construction system 200 may also merge texts having a higher degree of similarity than a preset similarity level, among the texts represented by the pre-processed data included in a cluster, according to a preset merging method. Word similarities may be used in the predetermined merging method.

The clustering unit 230 may represent texts whose coordinates are placed within a predefined distance to be included in a cluster, like the clustering unit 140 shown in FIG. 6.

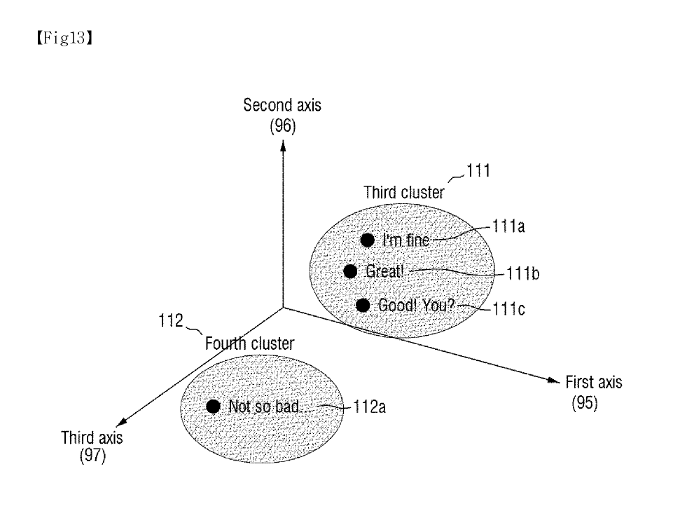

FIG. 12 is a diagram illustrating an example of a clustering operation performed by a clustering unit (140, 230).

Referring to FIG. 12, texts corresponding to the vectorized data in FIG. 11 are clustered based on the degree of text similarity.

Referring to FIG. 12, the texts “Did you have lunch?” and “Did you have dinner?,” which are placed to be relatively near to each other, are included in one and the same cluster, i.e., a first cluster 101. In addition, the text “Did you have time?” is positioned to be relatively far from the “Did you have lunch?” and “Did you have dinner?” and is included in a second cluster 102, which is different from the first cluster 101.

As described above, the degree of similarity may be determined according to the setting data of the respective axes 96, 97 and 98. The setting data of the respective axes 96, 97 and 98 may vary according to the information concerning time, place, and user of a newly received message and information concerning a messaging counterpart.

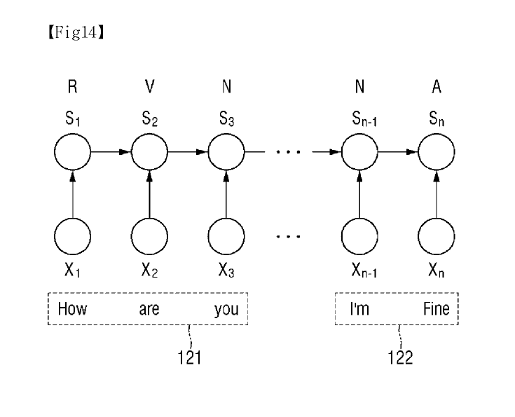

FIG. 13 illustrates response message that may be recommended when the received message 113 is “How are you?”

In response to the received message 113, texts represented by pieces of data included in a third cluster 111 are “I'm fine” 111a, “Great!” 111b and “Good! You?” 111c, which are similar to one another as affirmative replies to the received message 113.

A text represented by data included in a fourth cluster 112 is “Not so bad . . . ” 112a, which is a less affirmative reply than the replies included in the third cluster 111 or a neutral reply. The respective axes 113, 114 and 115 shown in FIG. 13 may have different properties from the respective axes 96, 97 and 98 shown in FIG. 10. That is to say, assuming that a parent text is “How are you,” the respective axes 113, 114 and 115 shown in FIG. 13 may include child texts indicating degrees of affirmation, neutrality and negation.

Referring back to FIG. 6, the ranking unit 150 may perform scoring on each of the clusters.

In detail, the ranking unit 150 may perform scoring on the degree of appropriateness as the reply to the received message for each cluster using a first preset scoring method.

Alternatively, the ranking unit 150 may also perform scoring on a merged text.

In detail, the ranking unit 150 may perform scoring on the merged text using a second preset scoring method as to the degree of appropriateness of the merged text as the reply to the received message.

The merged text may mean a single text created by merging similar texts. Here, the texts existing in a cluster without being merged may also be taken as the merged text to be assigned with a score.

That is to say, when similar texts “A,” “B” and “C” and slightly different texts “D” and “E” exist in a particular cluster and the similar texts “A,” “B” and “C” are merged into the text “A,” the merged texts to be assigned with scores by the ranking unit 150 would be “A,” “D” and “E”. The merged text may not be necessarily one of the texts existing in the cluster. For example, the similar texts “A,” “B” and “C” may also be merged into a text “F”.

In addition, the ranking unit 150 may first perform scoring on each cluster and may secondarily perform scoring on texts existing in clusters having higher scores than a first preset score.

The ranking unit 150 may assign a higher score to a cluster having a larger size. When a cluster is referred to as a cluster having a large size, it may mean that the large sized cluster is most frequently selected as the reply to the received message and includes many similar texts.

Since the ranking unit 150 is ultimately used to determine an appropriate text as the reply to the received message, it may perform scoring using the first preset scoring method or the second preset scoring method in consideration of the intent, time, place or situation of the received message.

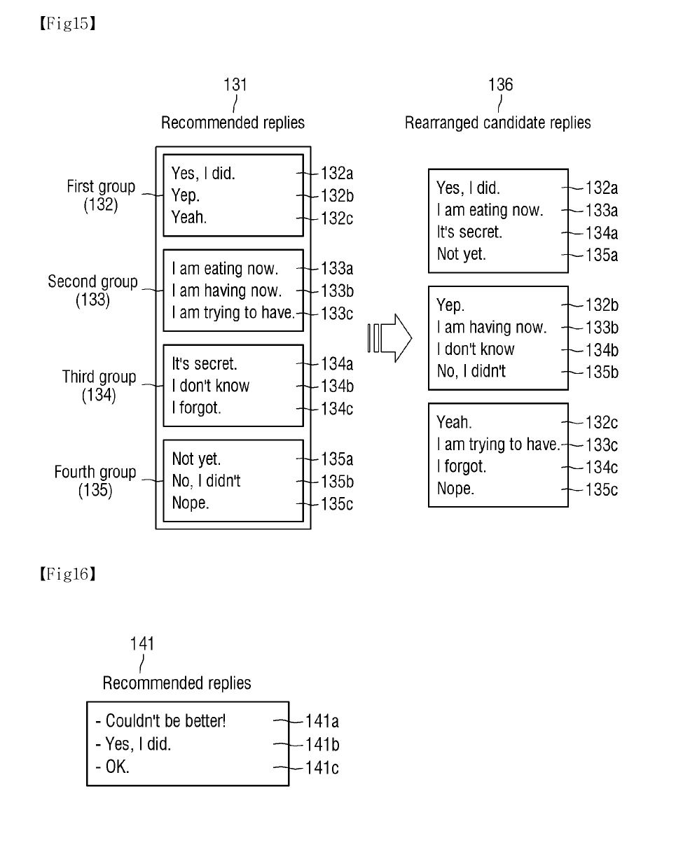

FIG. 14 is a diagram illustrating an example of a ranking operation performed by a ranking unit (150).

The ranking unit 150 may perform scoring using combinations of various methods, rather than performing scoring just by the method described with reference to FIG. 12.

Referring to FIG. 14, the ranking unit 150 may perform scoring using a calculated probability that a following text (possibly consisting of only word(s) occurs based on a current text created from a parent text compiled with child texts, which will now be described in detail with regard to, for example, a word relationship.

Since no preceding word exists, there is no choice but to determine the word “How” itself as an adverb. However, the word “are” may be subordinate to “How” and the word “you” may be subordinate to “How are”. Since the word “You” follows “adverb+verb,” it is a highly probable word to be used as a noun, which may be learned from the dialog pair data compiled with parent text and child texts. That is to say, when a text “how+are+you” (121) composed of adverb(R)+verb(V)+noun(N) appears, it is possible to predict a word and a part of speech (POS) following the text 121. For example, a word “thanks” has a very slim probability of occurring following “how+are+you” and is assigned with a low score.

The ranking unit 150 may perform scoring on each cluster and/or each text to deduce recommended reply suitable to the received message using probabilities calculated by the text structure and variety of data and methods, including cluster size, frequency of occurrence of similar texts, frequency of occurrence of related texts in the collected dialog pair data.

The texts assigned with scores by the ranking unit 150 and determined to have scores higher than or equal to a preset score may be deduced as recommended replies.

In addition, among the texts assigned with scores by the ranking unit 150, a predetermined number of texts assigned with scores in a descending order may also be deduced as recommended replies.

Moreover, among the texts assigned with scores by the ranking unit 150 and determined to have scores higher than or equal to a preset score, as many texts as a predetermined number of texts assigned with scores in a descending order may also be deduced as recommended replies.

In a case where a cluster having a high score is determined by the ranking unit 150, texts included in the determined cluster may be deduced as recommended replies.

When scoring is performed on each of clusters or when scoring is first performed on each of clusters and scoring is secondarily performed on each text with respect to only the clusters assigned with scores higher than or equal to a preset score, computation quantities may be reduce, compared to a case when scoring is performed on each text.

In addition, the ranking unit 150 may deduce at least one text from each cluster as recommended replies by first performing scoring on each cluster and then secondarily performing scoring on the clusters having scores higher than or equal to a preset score. In this case, the diversity of recommended replies may be enhanced.

One among the deduced recommended replies may be selected by the recommended reply providing unit 170 to then be visually and/or auditorily provided to a user who wants to reply the messaging counterpart.

However, before visually and/or auditorily provides the user with the recommended replies deduced by the ranking unit 150, the recommended reply providing unit 170 may perform grouping and then rearrange the deduced recommended replies to then be presented to the user.

In detail, the grouping unit 160 may perform grouping the texts recommended by the ranking unit 150 according to predetermined grouping criteria.

The grouping unit 160 may group similar replies using axis data, data relating to cluster locations on the coordinate system and/or contextual content of texts included in a cluster.

Alternatively, the grouping unit 160 may perform grouping in consideration of the content of each recommended reply.

For example, the grouping unit 160 may group the recommended replies into an affirmative group and a negative group.

Additionally, the grouping unit 160 may also group the recommended replies on the basis of four standards of affirmation, negation, excitement and security. For example, when the content of a recommended reply comes under rage, anger, disappointment, displeasure or anxiety, the recommended reply may be grouped into a first group coming under {negation, excitement}. In addition, when the content of a recommended reply comes under joy, pleasure or cheerfulness, the recommended reply may be grouped into a second group coming under {affirmation, excitement}.

When the content of a recommended reply comes under despair, languor or depression, the recommended reply may be grouped into a third group coming under {negation, security}. When the content of a recommended reply comes under serenity, peace or content, the recommended reply may be grouped into a fourth group coming under {affirmation, security}.

The grouping unit 160 may determine whether a word included in the text of the recommended reply comes under rage, anger, joy or pleasure.

The grouping unit 160 may change the grouping criteria of recommended replies according to the content of the received message.

For example, an outside context, such as time or location, or a criterion relating to user information, may be added to the grouping criteria of recommended replies.

In addition, the grouping criteria may be increased or decreased according to the number of recommended replies. That is to say, when there are a large number of recommended replies, the number of grouping criteria may be increased. Conversely, when there are a small number of recommended replies, the number of grouping criteria may be decreased.

The grouping criteria may also be changed according to the resources, e.g., CPU, the kind of device, or the size of display.

The same operation as described above may also be applied to the grouping unit 240 of the text construction system 200, and the grouping unit 240 may group clusters created by the clustering unit 230 according to predetermined grouping criteria.

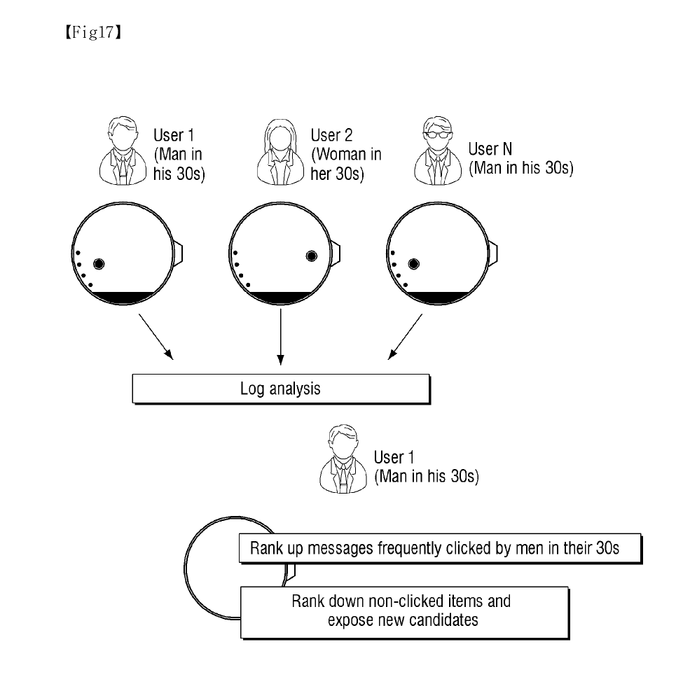

FIG. 15 is a diagram illustrating a grouping result of recommended replies.

As shown in FIG. 15, recommended replies 131 may include reply grouping results from the deducing by the ranking unit 150.

The grouping unit 160 may group recommended replies 132a to 135c according to whether the recommended replies 132a to 135c are affirmative, underway, uncertain, or negative.

The recommended replies “Yes, I did.” (132a), “Yep.” (132b) and “Yeah.” (132c) are included in the first group 132 coming under affirmation. The recommended replies “I am eating now.” (133a), “I am having now.” (133b) and “I am trying to have.” (133c) are included in the second group 133. The recommended replies “It's secret.” (134a), “I don't know.” (134b) and “I forgot.” (134c) are included in the third group 134. The recommended replies “Not yet.” (135a), “No, I didn't” (135b) and “Nope.” (135c) are included in the fourth group 135.

The recommended reply providing unit 170 may sequentially provide texts of different groups to the user as recommended replies, instead of consecutively providing texts of the same group.

In FIG. 15, for example, the recommended reply providing unit 170 may rearrange the recommended replies 131 and may provide the rearranged recommended replies 136.

In detail, one among the texts included in the first group 132, that is, “Yes, I did.”(132a), may first be presented to the user, one among the texts included in the second group 133, that is, “I am eating now.”(133a), may then be presented to the user. Then, one among the texts included in the third group 134, that is, “It's secret.”(134a), may finally be presented to the user. In the rearranged recommended replies 136, the texts of the same group are not consecutively provided.

That is to say, even if three texts 132a, 132b and 132c included in the first group 132 are assigned with scores by the ranking unit 150 with three highest scores, the three texts 132a, 132b and 132c may not be first presented to the user but may be presented to the user in combination with texts of other groups.

In such a manner, the user may easily select the content of a reply that the user intends to make. That is to say, even if the user intends to make a reply having negative content, when recommended replies are not rearranged, it is not easy for the user to select the reply as intended because the texts 135a, 135b, and 135c coming under negation exist in a subordinated place in sequence. However, similar recommended replies are not consecutively provided but texts of different groups are provided one by one, thereby allowing the user to easily select replies in a diversity of content.

When scoring of the clusters is performed by the ranking unit 150 and the clusters are grouped, the recommended reply providing unit 170 may sequentially provide texts included in the clusters of different groups, instead of consecutively providing the texts included in the clusters of the same group as recommended replies.

Referring again to FIG. 6, the recommended reply providing unit 170 may provide the user with recommended replies in a visually distinctive manner and/or in an auditorily distinctive manner according to the degree of significance in visually and/or auditorily providing the user with the rearranged recommended replies.

The degree of significance may be determined according to the score assigned by the ranking unit 150. That is to say, the higher the score, the higher the degree of significance.

The recommended reply providing unit 170 provides the user with each of the recommended replies in a visually distinctive manner by varying placement orders, letter sizes, touch area sizes, letter colors, letter background colors and letter resolutions of the recommended replies.

Referring to FIG. 7, the text construction system 200 may transfer the three texts 132a, 132b and 132c assigned with three highest scores by the ranking unit 250 to the corresponding devices 2000 and 2001 through the communication network 10.

The devices 2000 and 2001 may perform functions similar to those of the recommended reply providing unit 170 of the reply recommendation apparatus 100 shown in FIG. 6 using a separate built-in application. Therefore, the text construction system 200 may complete the three texts 132a, 132b and 132c having the three highest scores within the devices 2000 and 2001 to then transfer the completed texts to the user.

FIG. 16 is a diagram illustrating an example of providing recommended replies in a visually distinctive manner.

Referring to FIG. 16, the recommended reply providing unit 170 provides the user with the recommended replies 141a, 141b and 141c such that letter sizes of texts in recommended replies 141 are gradually increased according to the increase in the score assigned by the ranking unit 150.

Alternatively, the recommended reply providing unit 170 may provide the user with a plurality of recommended replies sequentially representing high scores when the ranking unit 150 performs scoring on the degree of appropriateness as the reply to the received message for each cluster.

Alternatively, the recommended reply providing unit 170 may provide the user with the recommended replies in an auditorily distinctive manner by varying volume, intonation or tone.

Data relating to the reply selected by the user among the recommended replies may be used when the data is collected by the data collecting unit 110 and the reply recommendation apparatus 100 selects recommended replies. That is to say, the data relating to the reply selected by the user among the recommended replies may be used as feedback data.

The recommended reply providing unit 170 may propose to the user executing an application as a recommended reply. To this end, the data collecting unit 110 may collect information relating the application executed immediately after receiving a particular message, and the ranking unit 150 may perform scoring on the application when the same message as the particular message or a message similar to the particular message on the basis of a preset similarity level is received again.

The recommended reply providing unit 170 may provides a text “Execute the application assigned with a higher score than a second preset score.” as the recommended reply to the same or similar message.

For example, the recommended reply providing unit 170 may recommend execution of an alarming application as a recommended reply to a received message “Buy and bring beer when you come home.” Alternatively, the recommended reply providing unit 170 may recommend execution of a scheduling application as a recommended reply to a received message “See you in Gangnam at 7.”

The reply recommendation apparatus 100 may further include an application execution unit 180.

The application execution unit 180 may automatically execute a specific application as a reply to a received message.

For example, the application execution unit 180 may execute an application for lowering the temperature of an air-conditioner as a reply to a received message “Too hot.”

The application execution unit 180 may determine whether conditions for automatically executing an application based on the data relating to selection of execution of a specific application as a reply to the received message are satisfied. For example, when a message having the same or similar text to the text “Too hot” is received more than a predetermined number of times and an application for lowering the temperature of an air conditioner is executed, the application for lowering the temperature of the air conditioner may be executed.

Unlike the reply recommendation apparatus 100 shown in FIG. 6 including the recommended reply providing unit 170 and the application execution unit 180, the text construction system 200 shown in FIG. 7 may not include functional structures corresponding to the recommended reply providing unit 170 and the application execution unit 180. Each of devices 2000 and 20001 may include functional structures corresponding to the recommended reply providing unit 170 and the application execution unit 180 and may implement a function of automatic text construction through communication with the text construction system 200.

Referring again to FIG. 7, the text construction system 200 may receive a user' message and a reply selected by the user through the feedback collecting unit 260 to reflect the received message and reply on various steps. For example, the user's message and the reply selected by the user may be used by the ranking unit 250 in ranking modeling and evaluation or by the clustering unit 230 in indexing correct answers to determine priority of user data in merging similar texts.

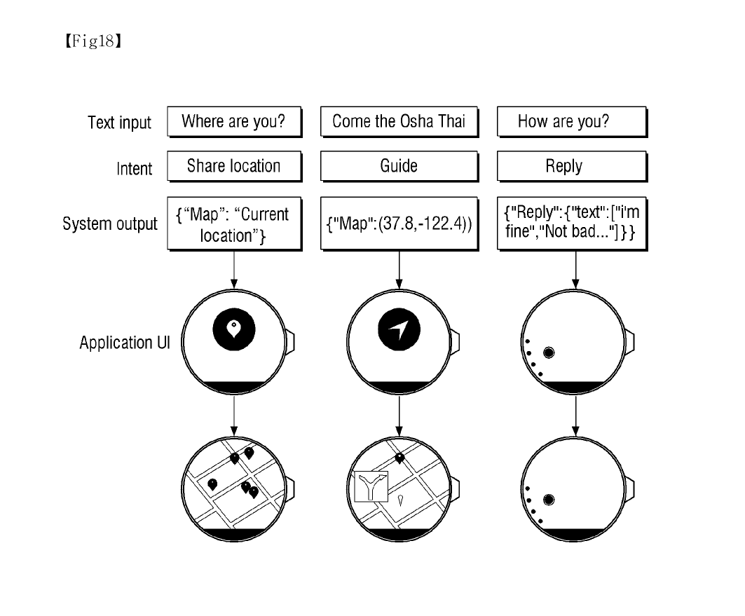

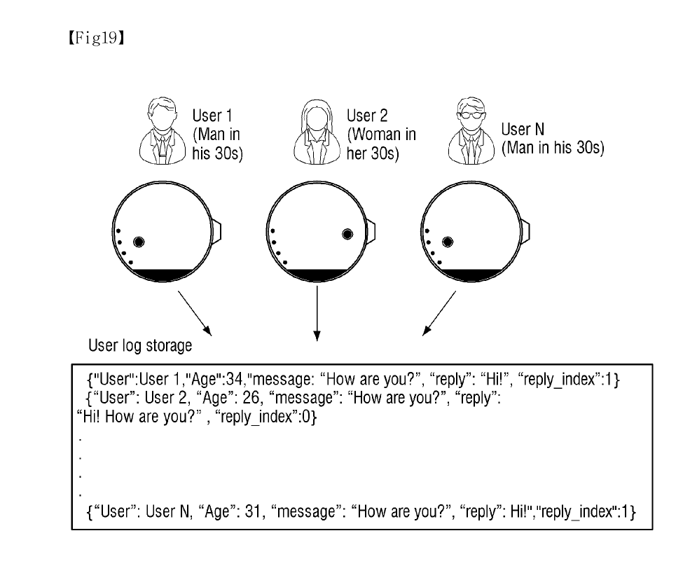

FIG. 17 is a diagram illustrating an example of a personalized ranking operation and FIG. 18 is a diagram illustrating an example of a ranking operation with consideration taken into user's intent.

Referring to FIG. 17, as the example of a personalized ranking operation, user's feedback enables accuracy improvement and personalized ranking In a case where a new user is in his 30s, inclination of a man in his 30s among existing users may be taken into consideration in recommending a reply suitable to the new user.

Therefore, automatically constructed texts adaptive to the data relating to the new user are provided through analysis of log data for a man in his 30s among multiple users, including user 1 to user N.

Next, referring to FIG. 18, if a text “Where are you?” is input, {Location sharing} is grasped as a following event intent for the input text and a system output {“Map”: “Current location”} is passed through, thereby constructing an App UI sharing location data.

Here, the current location may be created using GPS data relating to user's current location, and a deep link is generated based on the current location to directly accessing a screen showing the current location on a map App installed in each of the user devices 2000 and 2001. In a case where the deep link is used, an initial screen of the map App is not necessarily executed and a command corresponding to the current location may be transmitted without a user input.

In particular, during the conversation between the devices 2000 and 2001, when the user 1 inputs a message “Where are you?,” the device 2001 of the user 2 receives GPS data representing current location data of the user 1 in the form of {“Map”: “Current location”} from the text construction system 200 and the current location of the user 1 is demonstrated on the map App installed in the device 2001.

In another embodiment, if a text “Come to Osha Thai” is input, {Guide} is grasped as a following event intent for the input text and a system output {“Map”: (37.8, −122.4)} is passed through, thereby constructing a guide App UI for moving to Osha Thai.

During the conversation between the devices 2000 and 2001, when the user 1 inputs a message “Come to Osha Thai,” the device 2001 of the user 2 receives data relating to an object of Osha Thai input by the user 1 in the form of {“Osha Thai”(37.8, −122.4)} from the text construction system 200, and the guide App corresponding to the received data may be executed. Here, the device 2001 of the user 2 may create a deep link from {“Osha Thai”(37.8, −122.4)} received from the device 200 of the user 1, thereby providing App service automatically driven by deep linking.

The reply recommendation apparatus 100 is mounted in each of the devices 2000, 2001 and 2100 without a separate system. Therefore, when the user 1 inputs a text “where are you” or “come to Osha Thai,” the data pre-processing unit 120 of the reply recommendation apparatus 100 in the device 2000 of the user 1 recognizes the text input, matches an object {“Map”: “Current location”} or {“Osha Thai”(37.8, −122.4)} to tagging data corresponding thereto, thereby transmitting the text to the device 2001 of the user2.

Alternatively, if a following event intent for the input text “How are you?” is grasped as a reply to the received message and a system output {“Reply”: {“text”: [“I'm fine”, “Not bad . . . ”]}} is passed through, thereby constructing a reply App UI.

FIG. 19 is a diagram illustrating an example of a text construction system (200) storing log data relating to multiple users using a feedback collecting unit (255).

Referring to FIG. 19, the data relating to multiple users and texts selected by the respective users are stored in a user log storage.

When the user 1 is a man at the age of 34 and selects a message {Hi!} as a reply to the message {How are you?}, log data of the user 1 may be stored in the user log storage in the form of {“User”: User 1, “Age”: 34, “message”: “How are you?”, “reply”: “Hi!”, “reply_index”:1}. When the user 2 is a woman at the age of 26 and selects a message {Hi! how are you?} as a reply to the message {How are you?}, log data of the user 2 may be stored in the user log storage in the form of {“User”: User 2, “Age”: 26, “message”: “How are you?”, “reply”: “Hi! How are you?”, “reply_index”:0}.

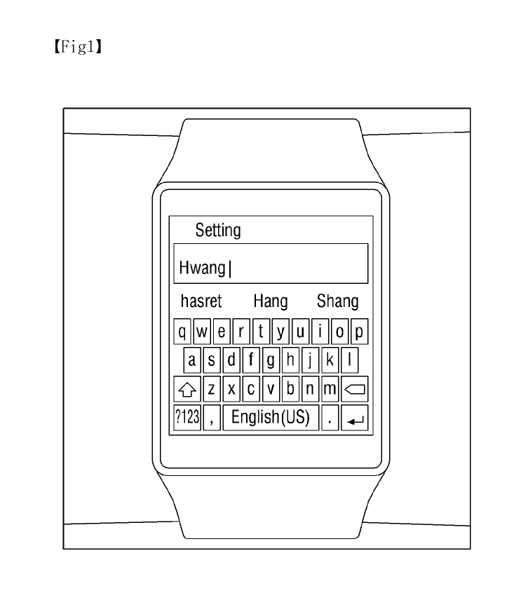

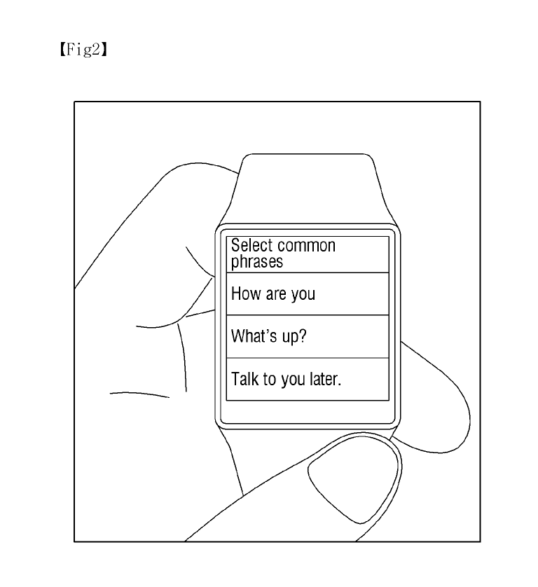

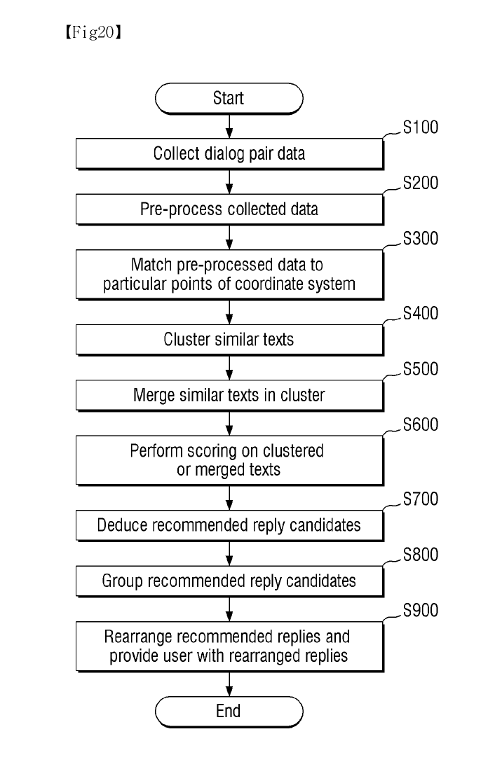

Hereinafter, a reply recommendation method according to another embodiment of the present invention will be described with reference to FIG. 20. The present embodiment can be performed by a computing device including calculating means. The computing device may be, for example, the reply recommendation apparatus 100 or the text construction system 200 according to an embodiment of the present invention. Configurations and operations of the reply recommendation apparatus 100 and the text construction system 200 may be understood from the content described with reference to FIGS. 1 to 19.

FIG. 20 is a flowchart of a reply recommendation method according to another embodiment of the present invention.

Referring to FIG. 20, the computing device may collect dialog pair data through the SNS (S100).

The computing device may pre-process the collected dialog pair data (S200).

The computing device may match the pre-processed data to particular points of the coordinate system for vectorization (S300).

The computing device may cluster similar texts using vector data (S400). The computing device may merge similar texts having a higher degree of similarity than a preset similarity level in each cluster (S500).

The computing device may perform scoring on clustered or merged texts (S600). The computing device may deduce recommended reply candidates using scoring data (S700).

The computing device may perform grouping on the deduced recommended reply candidates according to predetermined grouping criteria (S800). The computing device may rearrange the recommended replies to then present the rearranged replies to the user (S900).

While various operations are performed in a given sequence in the illustrated embodiment, it should not be understood that the operations are to be performed in the given sequence or the operations are to be sequenced in regular series to obtain desired results. Multitasking and pipelined processing would be desirable in specific circumstances. Moreover, it should not be understood separation of various components, like in the above-described embodiments, is essentially required. Rather, it should be understood that the above-described program components and systems are generally incorporated into a single software product or packaged in multiple software products.

For example, the grouping performed by the grouping unit 160 may be initiated earlier than the ranking unit 150. In detail, after recommended reply candidates or reply candidates are grouped by the grouping unit 160, the ranking unit 150 may perform scoring on each group and texts included in each group. In addition, at least one of the vectorizing unit 130, the clustering unit 140, the ranking unit 150 and the grouping unit 160 may not operate or may vary in its operation sequence according to the data relating to received message, the kind and quantity of reply candidates or the data relating to predefined axes.

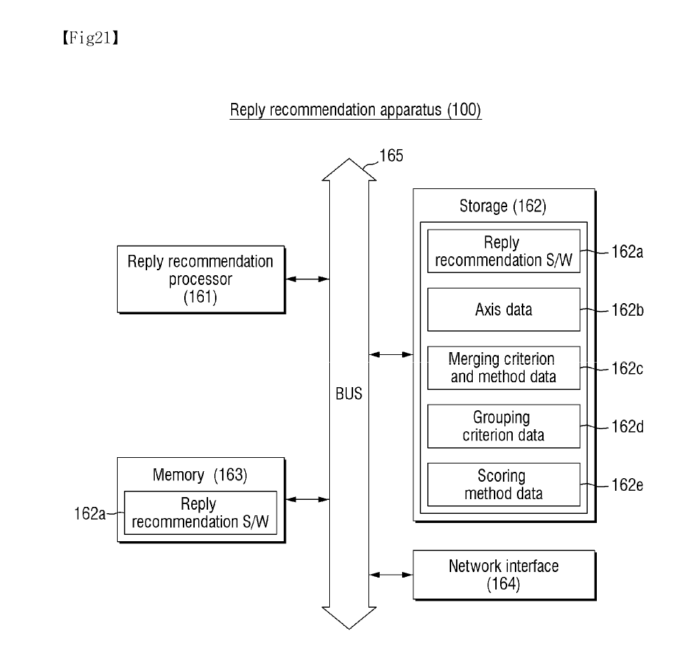

FIG. 21 is a diagram illustrating an exemplary hardware configuration of a reply recommendation apparatus according to an embodiment of the present invention.

The reply recommendation apparatus 100 according to the present embodiment may have the same configuration as shown in FIG. 20.

The computing device capable of performing a reply recommendation method according to another embodiment of the present invention may also have the same configuration as shown in FIG. 21.

As shown in FIG. 21, the reply recommendation apparatus 100 may include a reply recommendation processor 161, a storage 162, a memory 163 and a network interface 164.

In addition, the reply recommendation apparatus 100 may include a reply recommendation processor 161 and a bus 165 connected to the memory 163 and functioning as a data moving path.

Another computing device may be connected to the network interface 164. For example, the computing device connected to the network interface 164 may be a display device, a user terminal, or the like.

The network interface 164 may be an Eithernet, FireWire, USB, or the like.

The storage 162 may be implemented by, but not limited to, a nonvolatile memory device, such as a flash memory, or a hard disk.

The storage 162 stores data of a reply recommending computer program 162a. The data of the reply recommending computer program 162a may include binary execution files and other resource files.

In addition, the storage 162 may also store axis data 162b, merging criterion and method data 162c, grouping criterion data 162d, and scoring method data 162e.

The memory 163 loads the reply recommending computer program 162a. The reply recommending computer program 162a is provided to the reply recommendation processor 161 and is executed by the reply recommendation processor 161.

The reply recommendation processor 161 is a processor capable of executing the reply recommending computer program 162a. However, the reply recommendation processor 161 may not be a dedicated processor to execute only the reply recommending computer program 162a. For example, the reply recommendation processor 161 may also execute programs other than the reply recommending computer program 162a.

The reply recommending computer program 162a may include a series of operations including collecting dialog pair data including parent text data corresponding to a query and child text data corresponding to a reply to the query, pre-processing the collected data pair data, matching the pre-processed data to particular points on the coordinate system having predefined axes, performing clustering using information on the matched particular points and merging similar texts included in one of clusters according to a preset merging method, scoring the degree of appropriateness as a reply to the received message for each of the merged texts included in the clusters after the merging, grouping the texts having scores higher than a preset score or grouping a predetermined number of texts in descending order starting from one having the highest score according to predetermined grouping criteria, and sequentially providing texts of different groups resulting from the grouping, instead of consecutively providing texts of the same group.

Alternatively, the reply recommending computer program 162a may also include a series of operations including collecting dialog pair data including parent text data corresponding to a query and child text data corresponding to a reply to the query, pre-processing the collected data pair data, matching the pre-processed data to particular points on the coordinate system having predefined axes, performing clustering using information on the positioned particular points and merging all or some of texts included in one of clusters according to a preset merging method, scoring the degree of appropriateness as a reply to the received message for each of the clusters using a first preset scoring method, grouping the clusters having scores higher than a first preset score or grouping a predetermined number of clusters having scores represented in a descending order according to predetermined grouping criteria, and providing recommended replies sequentially represented by starting from one having the highest score assigned in the scoring of the degree of appropriateness.

Various components shown in FIG. 5 may mean be implemented, at least in part, in software or hardware, including field programmable gate arrays (FPGAs), application specific integrated circuits (ASICs), and so on. However, the components are not limited to software or hardware, but may be configured to reside in addressable storage media or may be configured to execute one or more processors. The functions provided by the components may be either divided into a larger number of elements or may be combined into a single element to perform a particular function.

The aforementioned embodiments shown in FIGS. 1 to 21 may be implemented by executing a computer program including computer-readable codes. The computer program may be transmitted from a first computing device to a second computing device through a network, such as the Internet, to then be installed in the second computing device. In such a manner, the computer program can be used in the second computing device. The first computing device and the second computing device may encompass all of fixed computing devices, such as desktop PCs, mobile computing device, such as notebook computers, smart phones, or tablet PCs, and wearable computing devices, such as smart watches, or smart glasses.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A reply recommendation apparatus comprising:
a data collecting unit collecting dialog pair data including parent text data corresponding to a query and child text data corresponding to a reply to the query;
a data pre-processing unit pre-processing the collected data pair data;
a vectorizing unit matching the pre-processed data to particular points on the coordinate system having predefined axes;
a clustering unit performing clustering using information on the matched particular points and merging all or some of texts included in each of clusters using a preset merging method;
a ranking unit scoring the degree of appropriateness as a reply to the received message for each of the clusters using a first preset scoring method; and
a recommended reply providing unit providing recommended replies sequentially represented by high scores assigned when the ranking unit scores the degree of appropriateness.

2. The reply recommendation apparatus of claim 1, further comprising a grouping unit grouping the clusters having scores higher than a first preset score or grouping a predetermined number of texts in descending order starting from one having the highest score according to predetermined grouping criteria, wherein the recommended reply providing unit sequentially provides texts included in clusters of different groups resulting from the grouping, instead of consecutively providing texts included in clusters of the same group.

3. The reply recommendation apparatus of claim 1, wherein the data collecting unit collects the dialog pair data on a social network service (SNS), and the data pre-processing unit removes SNS data characteristics from the dialog pair data collected on the SNS.

4. The reply recommendation apparatus of claim 3, wherein the data pre-processing unit separating a text on a token basis with respect to the dialog pair data from which the SNS data characteristics are removed and performing part-of-speech (POS) tagging on each token.

5. The reply recommendation apparatus of claim 4, wherein the data pre-processing unit performs entity extraction and metadata mapping on the POS tagged dialog pair data.

6. The reply recommendation apparatus of claim 1, wherein the predefined axes include at least one of text types and characteristics of words included in the text.

7. The reply recommendation apparatus of claim 1, wherein the ranking unit performs scoring on the clusters assigned with higher scores according to the bigger sizes of the clusters.

8. The reply recommendation apparatus of claim 2, wherein the ranking unit performs scoring on texts existing in the grouped clusters using a second preset scoring method.

9. The reply recommendation apparatus of claim 8, wherein the recommended reply providing unit provides recommended replies in a temporally in different ways based on scores assigned using the second preset scoring method.

10. The reply recommendation apparatus of claim 9, wherein the recommended reply providing unit provides recommended replies in a visually distinctive manner by varying at least one of placement order, letter size, touch area size, letter color, letter background color and letter resolution according to the scores assigned using the second preset scoring method.

11. The reply recommendation apparatus of claim 8, wherein the recommended reply providing unit provides recommended replies auditorily in different based on scores assigned using the second preset scoring method.

12. The reply recommendation apparatus of claim 11, wherein the recommended reply providing unit provides recommended replies in an auditorily distinctive manner by varying at least one of volume, intonation and tone.

13. The reply recommendation apparatus of claim 2, wherein the grouping unit performs grouping using at least one of information relating to cluster placement areas on the coordinate system and contextual content of each of texts included in the clusters.

14. The reply recommendation apparatus of claim 13, wherein the grouping unit performs grouping by additionally using at least one of receiving time of the received message, receiving place of the received message, sex of receiving user of the received message, and age of receiving user of the received message.

15. The reply recommendation apparatus of claim 2, wherein the degree of grouping performed by the grouping unit is changed according to the number of clusters to be grouped.

16. The reply recommendation apparatus of claim 2, wherein the data collecting unit collects information relating to user's reply to the received message and the ranking unit uses the information relating to user's reply in the scoring.

17. The reply recommendation apparatus of claim 2, wherein the data collecting unit collects information relating to an application executed immediately after receiving a particular message, when the same message as the particular message or a message similar to the particular message on the basis of a preset similarity level is received again, the ranking unit performs scoring on the received message by application based on the information relating to application execution, and the recommended reply providing unit provides a text “Execute the application assigned with a higher score than a second preset score.” as the recommended reply to the same or similar message.

18. The reply recommendation apparatus of claim 2, wherein the data collecting unit collects information relating to an application executed immediately after receiving a particular message, when the same message as the particular message or a message similar to the particular message on the basis of a preset similarity level is received again, the ranking unit performs scoring on the received message by application based on the application executing information, and the reply recommendation apparatus further comprises an application execution unit automatically executes the application assigned with the highest score when the same message as the particular message or a message similar to the particular message.

19. A reply recommendation apparatus comprising:
a data collecting unit collecting dialog pair data including parent text data corresponding to a query and child text data corresponding to a reply to the query;
a data pre-processing unit pre-processing the collected data pair data;
a vectorizing unit matching the pre-processed data to particular points on the coordinate system having predefined axes;
a clustering unit performing clustering using information on the matched particular points and merging similar texts included in one of clusters using a preset merging method;
a ranking unit scoring the degree of appropriateness as a reply to the received message for each of the merged texts included in the clusters after the merging;
a grouping unit grouping the texts having scores higher than a preset score or grouping a predetermined number of texts in descending order starting from one having the highest score according to predetermined grouping criteria; and
a recommended reply providing unit sequentially providing texts of different groups resulting from the grouping, instead of consecutively providing texts of the same group.

20. The reply recommendation apparatus of claim 19, wherein the ranking unit calculates a probability of the merged texts appearing after the received message and performs scoring on the merged texts based on the calculated probability.

21. A reply recommendation method comprising:
collecting dialog pair data including parent text data corresponding to a query and child text data corresponding to a reply to the query;
pre-processing the collected data pair data;
matching the pre-processed data to particular points on the coordinate system having predefined axes;
performing clustering using information on the matched particular points and merging similar texts included in one of clusters using a preset merging method;
scoring the degree of appropriateness as a reply to the received message for each of the merged texts included in the clusters after the merging;
grouping the texts having scores higher than a preset score or grouping a predetermined number of texts in descending order starting from one having the highest score according to predetermined grouping criteria; and
sequentially providing texts of different groups resulting from the grouping, instead of consecutively providing texts of the same group.

22. A reply recommendation method comprising:
collecting dialog pair data including parent text data corresponding to a query and child text data corresponding to a reply to the query;
pre-processing the collected data pair data;
matching the pre-processed data to particular points on the coordinate system having predefined axes;
performing clustering using information on the positioned particular points and merging all or some of texts included in one of clusters using a preset merging method;
scoring the degree of appropriateness as a reply to the received message for each of the clusters using a first preset scoring method;
grouping the clusters having scores higher than a first preset score or grouping a predetermined number of texts in descending order starting from one having the highest score according to predetermined grouping criteria; and
providing recommended replies sequentially represented by high score assigned in the scoring of the degree of appropriateness.

23. A computer readable medium comprising a computer program, which in combination with hardware, the computer program stored in a medium configured to perform the reply recommendation method of claim 21.
